(19) United States
(12) Patent Application Publication
(10) Pub. No.: US 2020/0104503 A1
(43) Pub. Date: Apr. 2, 2020

(54) INFORMATION PROCESSING APPARATUS, INFORMATION PROCESSING METHOD, AND COMPUTER READABLE MEDIUM

(71) Applicant: Mitsubishi Electric Corporation, Tokyo (JP)

(72) Inventors: Aiko IWASAKI, Tokyo (JP); Kiyoto KAWAUCHI, Tokyo (JP)

(73) Assignee: Mitsubishi Electric Corporation, Tokyo (JP)

(21) Appl. No.: 16/470,053

(22) PCT Filed: Feb. 8, 2017
(86) PCT No.: PCT/JP2017/004636

§ 371 Date: Jun. 14, 2019

(51) Int. Cl. G06F 21/57; G06F 8/65; G06F 21/55

(52) U.S. Cl. CPC G06F 21/57; G06F 2221/033; G06F 21/552; G06F 8/65

(57) ABSTRACT

A reception unit receives communication packet data used for updating of a current program that is transmitted from a maintenance terminal apparatus. A control program construction unit acquires an updated program for the current program as a packet-updated program, using the communication packet data. A difference determination unit analyzes a difference between the current program and the packet-updated program and determines a probability that the packet-updated program is a normal updated program for the current program.

### TECHNICAL FIELD

The present invention relates to program updating.

### BACKGROUND ART

Cyberattacks caused by viruses or pieces of malicious unauthorized software (malware) have increased in recent years. For example, cyberattacks caused by viruses or pieces of unauthorized software on a plant or a factory which constitutes a significant infrastructure have been increasing.

For example, Patent Literature 1 discloses an intrusion prevention system which detects an intrusion into and an abnormality in an industrial control system. When the industrial control system suffers a cyberattack, unauthorized access causes the industrial control system to exhibit unauthorized behavior. For this reason, the intrusion prevention system according to Patent Literature 1 detects an intrusion into and an abnormality in the industrial control system by monitoring network communication and measuring control system behavior (parameters).

In Patent Literature 2, a monitoring module monitors the operating state of a unit which performs control or adjustment, a hardware expansion state, a program state, and the like by monitoring the contents of memory which stores program code, a hardware configuration, a software configuration, and the like. The monitoring module detects an unauthorized manipulation as a result of the monitoring.

### CITATION LIST

### Patent Literature

Patent Literature 1: JP 2014-179074

Patent Literature 2: JP 2016-505183

### SUMMARY OF INVENTION

### Technical Problem

A maintenance task in a maintenance terminal apparatus is capable of a larger number of processes, such as updating of a control program, than in a general terminal apparatus. For example, the maintenance terminal apparatus can transmit communication packet data for updating a control program to a controller. If a worker performs a maintenance task using the maintenance terminal apparatus without noticing that the maintenance terminal apparatus is infected with a virus, communication packet data falsified by the virus is transmitted. As a result, a legitimate program is updated with an unauthorized program by the communication packet data falsified by the virus, and an abnormality occurs in a device to be maintained.

In either Patent Literature 1 or Patent Literature 2, however, a program which is updated with communication packet data transmitted from a program updating management apparatus configured to manage program updating, such as the maintenance terminal apparatus described earlier, is not inspected. For this reason, the techniques according to Patent Literature 1 and Patent Literature 2 suffer a problem in that, if a program updating management apparatus is infected with a virus, the techniques are incapable of preventing a program from being unauthorizedly updated by communication packet data transmitted from the program updating management apparatus.

The present invention has as one of major objects to solve the above-described problem. More specifically, the present invention mainly aims at preventing a program from being unauthorizedly updated by communication packet data transmitted from a program updating management apparatus.

### Solution to Problem

An information processing apparatus includes:

a reception unit to receive communication packet data used for updating of a current program, the communication packet data being transmitted from a program updating management apparatus which manages program updating;

a program acquisition unit to acquire an updated program for the current program as a packet-updated program, using the communication packet data; and

a normality probability determination unit to analyze a difference between the current program and the packet-updated program and to determine a probability that the packet-updated program is a normal updated program for the current program.

### Advantageous Effects of Invention

According to the present invention, it is possible to prevent a program from being unauthorizedly updated by communication packet data transmitted from a program updating management apparatus.

### BRIEF DESCRIPTION OF DRAWINGS

FIG. 1 is a diagram illustrating an example of a system configuration according to Embodiment 1.

FIG. 2 is a diagram illustrating an example of a hardware configuration of a normal task determination apparatus according to Embodiment 1.

FIG. 3 is a diagram illustrating an example of a functional configuration of the normal task determination apparatus according to Embodiment 1.

FIG. 4 is a flowchart illustrating an example of operation of the normal task determination apparatus according to Embodiment 1.

FIG. 5 is a flowchart illustrating an example of operation of a reception unit and a control program construction unit according to Embodiment 1.

FIG. 6 is a flowchart illustrating an example of operation of a past program storage unit according to Embodiment 1.

FIG. 7 is a flowchart illustrating an example of operation of a difference determination unit according to Embodiment 1.

FIG. 8 is a chart illustrating an example of a normality probability standard according to Embodiment 1.

FIG. 9 is a flowchart illustrating the example of the operation of the difference determination unit according to Embodiment 1.

FIG. 10 is a diagram illustrating an example of a functional configuration of a normal task determination apparatus according to Embodiment 2.

FIG. 11 is a flowchart illustrating an example of operation of a maintenance and construction schedule DB according to Embodiment 2.

FIG. 12 is a chart illustrating an example of a maintenance and construction schedule table according to Embodiment 2.

FIG. 13 is a flowchart illustrating an example of operation of a scheduled task determination unit according to Embodiment 2.

### DESCRIPTION OF EMBODIMENTS

Embodiments of the present invention will be described below with reference to the drawings. Components denoted by identical reference numerals in the following description of the embodiments and the drawings are identical or corresponding components.

### Embodiment 1

***Description of Configuration***

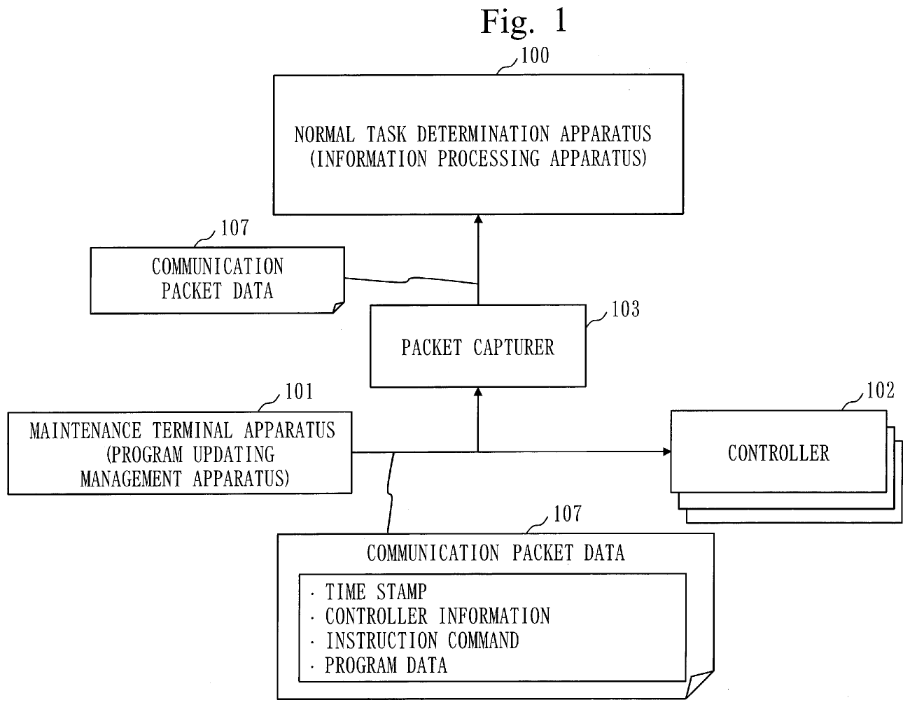

FIG. 1 illustrates an example of a system configuration according to the present embodiment.

As illustrated in FIG. 1, a system according to the present embodiment is composed of a normal task determination apparatus 100, a maintenance terminal apparatus 101, a plurality of controllers 102, and a packet capturer 103.

The normal task determination apparatus 100 corresponds to an information processing apparatus. An operation to be performed by the normal task determination apparatus 100 corresponds to an information processing method and an information processing program. Details of the normal task determination apparatus 100 will be described later.

The maintenance terminal apparatus 101 manages updating of a control program to be executed by each controller 102. The maintenance terminal apparatus 101 corresponds to a program updating management apparatus. The maintenance terminal apparatus 101 transmits communication packet data 107 to the controllers 102. The communication packet data 107 includes one used for control program updating and one not used for control program updating. Note that details of the communication packet data 107 will be described later.

The controller 102 is a device to be maintained, and a plurality of controllers 102 are present. Each controller 102 receives the communication packet data 107 from the maintenance terminal apparatus 101. If the controller 102 receives the communication packet data 107 used for control program updating, the controller 102 updates a control program using the received communication packet data 107. The controller 102 may install the updated control program in a different device.

Note that a control program before updating using the communication packet data 107 is performed will hereinafter be referred to as a current program. A control program which is obtained through updating using the communication packet data 107 will be referred to as a packet-updated program.

The packet capturer 103 collects the communication packet data 107 that are transmitted from the maintenance terminal apparatus 101 to the controllers 102 and transmits the collected communication packet data 107 to the normal task determination apparatus 100. The packet capturer 103 is implemented by, for example, an abnormality detection system using a whitelist.

Note that, as will be described later, the normal task determination apparatus 100 also updates a current program using the communication packet data 107 to acquire a packet-updated program.

Details of the communication packet data 107 will be described here. As illustrated in FIG. 1, the communication packet data 107 includes at least a time stamp, controller information, and an instruction command.

The time stamp indicates a time of generation of the communication packet data 107. The controller information indicates the controller 102 that is a destination of the communication packet data 107. The instruction command is an instruction to the controller 102 indicated by the controller information. If the communication packet data 107 is used for control program updating, a statement for generating a packet-updated program from program data which is to be described later is described in the instruction command.

The communication packet data 107 used for control program updating includes the program data. The program data is a partial program which is obtained by dividing a packet-updated program. That is, a packet-updated program is obtained by combining a plurality of pieces of program data.

The controller 102 transmits a plurality of pieces of communication packet data 107. The packet capturer 103 collects a plurality of pieces of communication packet data 107 transmitted from the maintenance terminal apparatus 101 and transmits the plurality of pieces of communication packet data 107 collected to the normal task determination apparatus 100. The normal task determination apparatus 100 receives the plurality of pieces of communication packet data 107 from the packet capturer 103, extracts the plurality of pieces of program data from the plurality of pieces of communication packet data 107, and combines the plurality of pieces of program data extracted to obtain the packet-updated program.

Note that although the communication packet data 107 includes data other than a time stamp, controller information, an instruction command, and program data, the inclusion is not directly related to the present embodiment, and a description thereof will be omitted.

The packet capturer 103 may transmit the communication packet data 107 to the normal task determination apparatus 100 without processing. Alternatively, the packet capturer 103 may extract only the time stamp, the controller information, the instruction command, and the program data from the communication packet data 107 and transmit only the time stamp, the controller information, the instruction command, and the program data that are extracted to the normal task determination apparatus 100. An example in which the packet capturer 103 transmits the communication packet data 107 to the normal task determination apparatus 100 without processing will be described below.

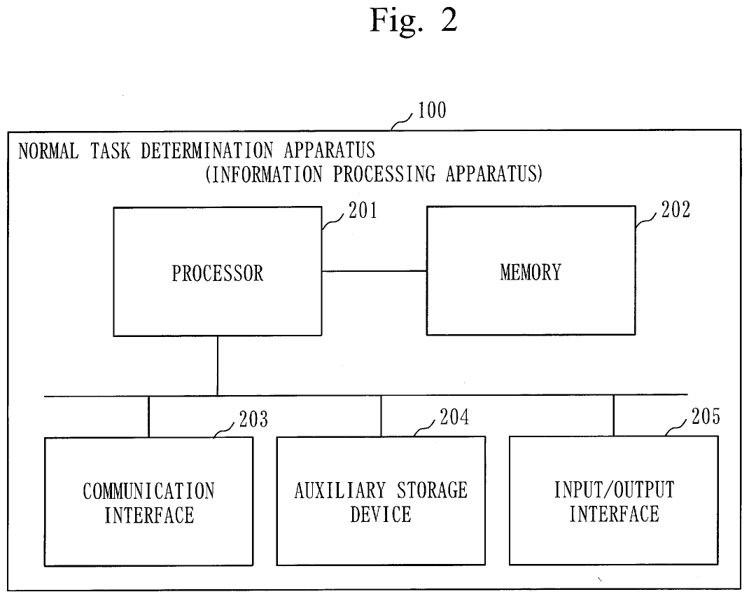

FIG. 2 illustrates an example of a hardware configuration of the normal task determination apparatus 100 according to the present embodiment.

The normal task determination apparatus 100 is a computer.

As illustrated in FIG. 2, the normal task determination apparatus 100 includes a processor 201, a memory 202, a communication interface 203, an auxiliary storage device 204, and an input/output interface 205 as hardware.

The processor 201, the memory 202, the communication interface 203, the auxiliary storage device 204, and the input/output interface 205 are connected by a system bus.

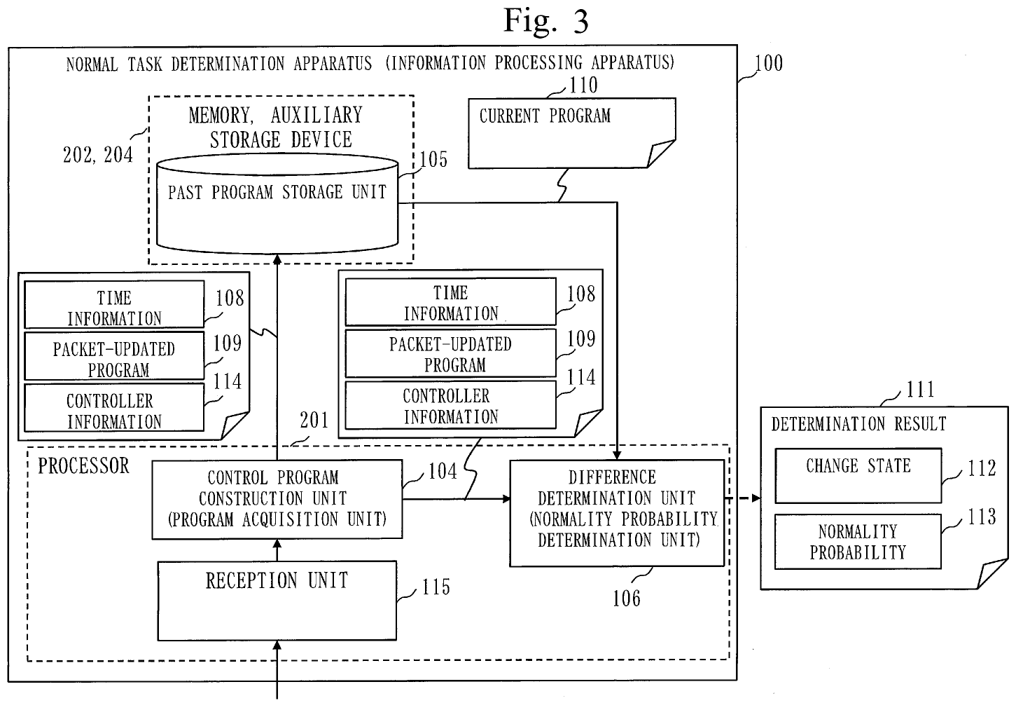

The auxiliary storage device 204 stores a program which implements functions of a control program construction unit 104, a difference determination unit 106, and a reception unit 115 which will be described later with reference to FIG. 3. The program is loaded into the memory 202. The program is read from the memory 202 by the processor 201 and is executed by the processor 201.

With the execution of the program by the processor 201, operation of the control program construction unit 104, the difference determination unit 106, and the reception unit 115 which will be described later is performed.

The communication interface 203 is used to communicate with the packet capturer 103.

The input/output interface 205 is used by a user of the normal task determination apparatus 100 to enter various types of data and is used to present various types of data to the user of the normal task determination apparatus 100.

FIG. 3 illustrates an example of a functional configuration of the normal task determination apparatus 100 according to the present embodiment.

As illustrated in FIG. 3, the normal task determination apparatus 100 is composed of the control program construction unit 104, a past program storage unit 105, the difference determination unit 106, and the reception unit 115.

The reception unit 115 receives, from the packet capturer 103, the communication packet data 107 that is transmitted from the maintenance terminal apparatus 101.

A process to be performed by the reception unit 115 corresponds to a reception process.

The control program construction unit 104 updates a current program using the communication packet data 107 and acquires, as a packet-updated program 109, an updated program for the current program. That is, the control program construction unit 104 extracts a plurality of pieces of program data from a plurality of pieces of communication packet data 107 and combines the plurality of pieces of program data extracted to generate the packet-updated program 109.

The control program construction unit 104 extracts, as time information 108, a time stamp included in the communication packet data 107. The control program construction unit 104 extracts controller information as controller information 114 from the communication packet data 107.

The control program construction unit 104 outputs the time information 108, the packet-updated program 109, and the controller information 114 to the difference determination unit 106.

The control program construction unit 104 also stores the time information 108, the packet-updated program 109, and the controller information 114 in the past program storage unit 105.

The control program construction unit 104 corresponds to a program acquisition unit. A process to be performed by the control program construction unit 104 corresponds to a program acquisition process.

The past program storage unit 105 stores a current program 110 and control programs previous to the current program 110. Note that the current program 110 and the control programs previous to the current program 110 are collectively referred to as past programs.

The past program storage unit 105 is implemented by the memory 202 or the auxiliary storage device 204.

The difference determination unit 106 receives, from the control program construction unit 104, the time information 108, the packet-updated program 109, and the controller information 114. The difference determination unit 106 also reads out the current program 110 from the past program storage unit 105. The current program 110 that is read out from the past program storage unit 105 by the difference determination unit 106 is a control program which is a latest previous version (before updating) of the packet-updated program 109 that is received from the control program construction unit 104.

The difference determination unit 106 analyzes a difference between the current program 110 and the packet-updated program 109 and determines the probability that the packet-updated program 109 is a normal updated program for the current program 110.

More specifically, the difference determination unit 106 analyzes the amount of the difference between the current program 110 and the packet-updated program 109 (for example, the number of changed lines) and the degree of change in a value of a parameter in which a value has changed between the current program 110 and the packet-updated program 109, so as to determine the probability that the packet-updated program 109 is a normal updated program for the current program 110.

Alternatively, the difference determination unit 106 may analyze only the amount of the difference between the current program 110 and the packet-updated program 109, so as to determine the probability that the packet-updated program 109 is a normal updated program for the current program 110.

The difference determination unit 106 outputs a determination result 111. The determination result 111 includes a change state 112 and a normality probability 113. The change state 112 is the difference between the current program 110 and the packet-updated program 109. The normality probability 113 is the probability that the packet-updated program 109 is a normal updated program for the current program 110 that is determined by the difference determination unit 106.

The difference determination unit 106 outputs the determination result 111 to, for example, a prescribed terminal apparatus (not illustrated). The difference determination unit 106 may output the determination result 111 to the terminal apparatus and also store the determination result 111 in the auxiliary storage device 204. Alternatively, the difference determination unit 106 may store the determination result 111 in the auxiliary storage device 204 without outputting the determination result 111 to the terminal apparatus. Alternatively, the difference determination unit 106 may output the determination result 111 to a display device which serves as the input/output interface 205.

The difference determination unit 106 corresponds to a normality probability determination unit. A process to be performed by the difference determination unit 106 corresponds to a normality probability determination process.

As described earlier, the control program construction unit 104, the difference determination unit 106, and the reception unit 115 are implemented by the program. The processor 201 executes the program and operates as the control program construction unit 104, the difference determination unit 106, and the reception unit 115.

FIG. 3 schematically represents a state in which the processor 201 is executing the program that implements the functions of the control program construction unit 104, the difference determination unit 106, and the reception unit 115.

***Description of Operation***

Operation of the normal task determination apparatus 100 according to the present embodiment will next be described.

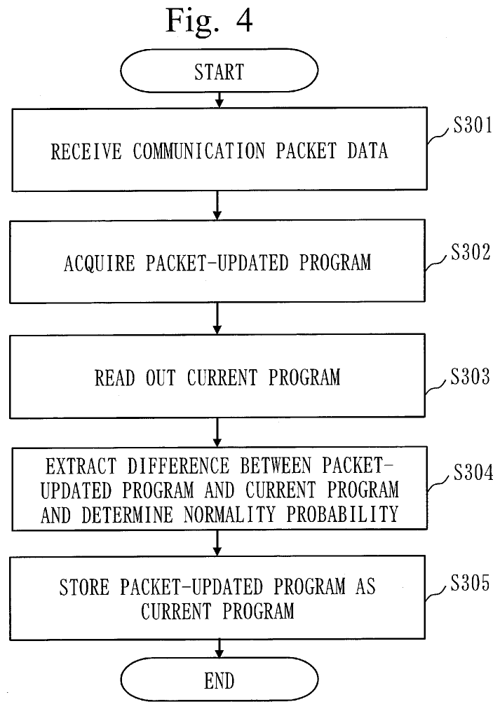

FIG. 4 illustrates an overview of the operation of the normal task determination apparatus 100.

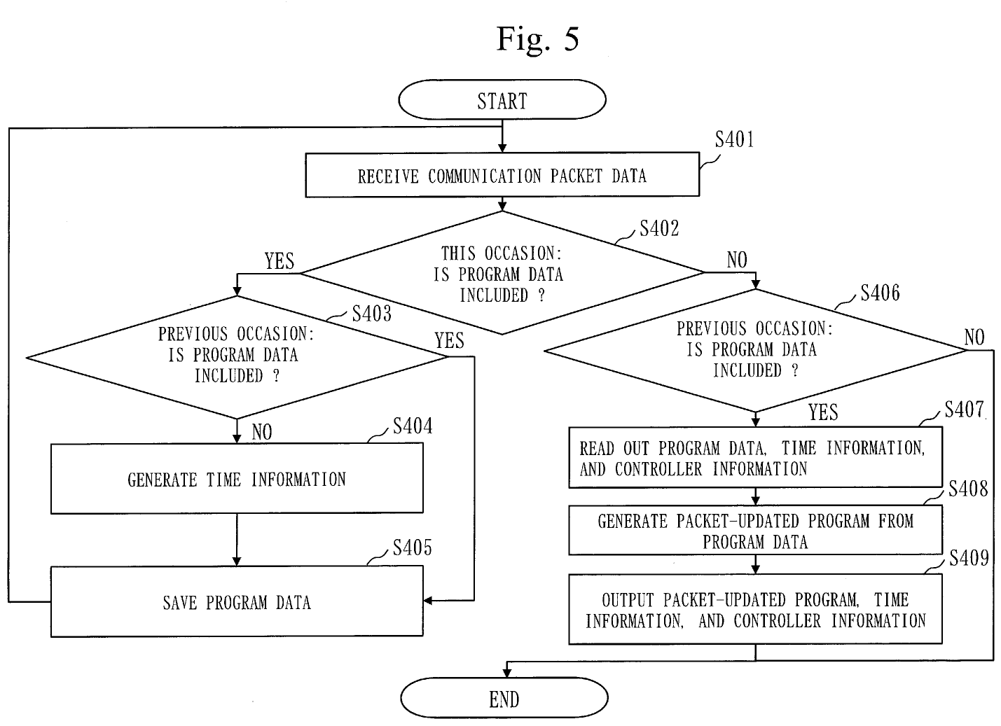

FIG. 5 illustrates operation of the reception unit 115 and the control program construction unit 104 (details of S301 and S302 in FIG. 4).

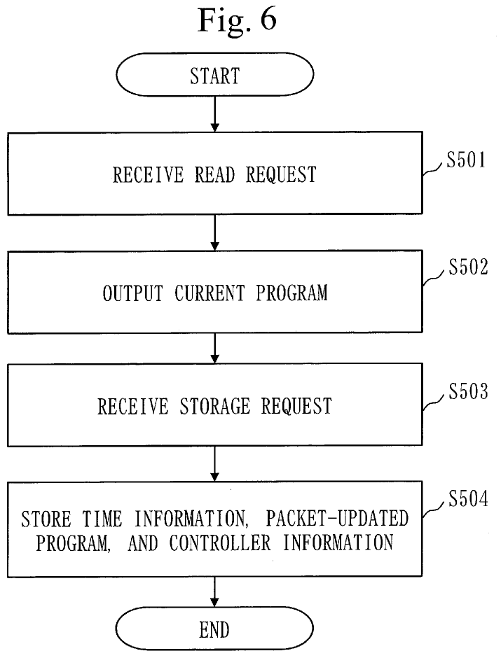

FIG. 6 illustrates operation of the past program storage unit 105 (details of S303 and S305 in FIG. 4).

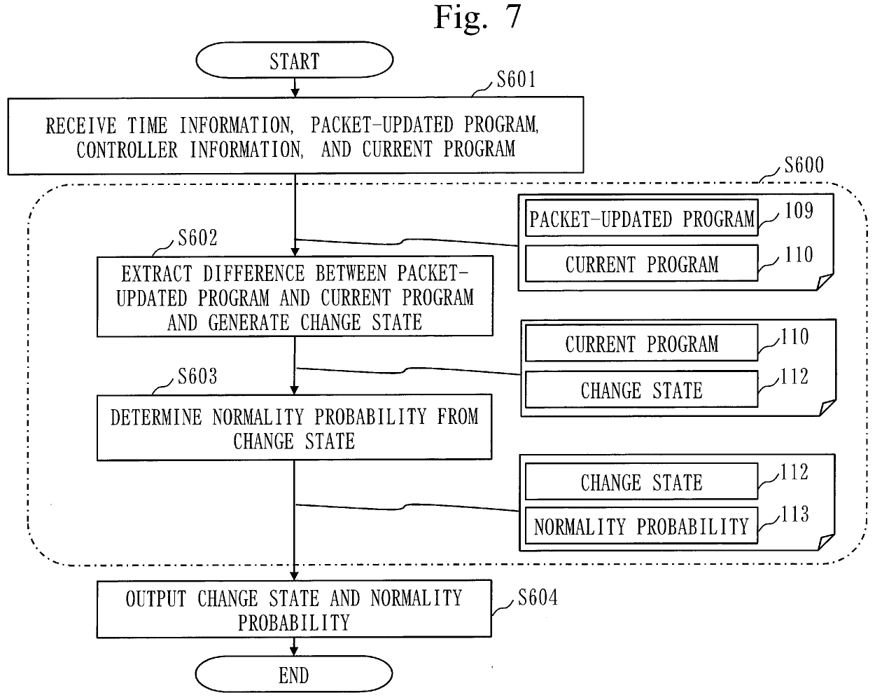

FIG. 7 illustrates operation of the difference determination unit 106 (details of S304 in FIG. 4).

The overview of the operation of the normal task determination apparatus 100 will be described first with reference to FIG. 4.

The reception unit 115 first receives the communication packet data 107 from the packet capturer 103 (step S301).

The reception unit 115 also outputs the communication packet data 107 to the control program construction unit 104.

The control program construction unit 104 then acquires the packet-updated program 109 using the communication packet data 107 (step S302).

The control program construction unit 104 transfers the packet-updated program 109, the time information 108, and the controller information 114 to the difference determination unit 106.

The difference determination unit 106 then reads out the current program 110 from the past program storage unit 105 (step S303).

The difference determination unit 106 then extracts a difference between the packet-updated program 109 and the current program 110 and determines a normality probability (step S304).

The difference determination unit 106 outputs the determination result 111.

If the normality probability determined by the difference determination unit 106 is equal to or less than a prescribed value, the control program construction unit 104 stores the packet-updated program 109 as the current program 110 in the past program storage unit 105 (step S305).

The operation of the reception unit 115 and the control program construction unit 104 will next be described with reference to FIG. 5.

Note that, as described earlier, the maintenance terminal apparatus 101 divides a packet-updated program into a plurality of partial programs and stores, as the program data, the plurality of partial programs in a plurality of pieces of communication packet data 107. The maintenance terminal apparatus 101 transmits the plurality of pieces of communication packet data 107 to the controller 102. The packet capturer 103 is connected to a network which connects the maintenance terminal apparatus 101 and the controllers 102, and collects the communication packet data 107 that are transmitted from the maintenance terminal apparatus 101 to the controllers 102 and transmits the collected communication packet data 107 to the normal task determination apparatus 100.

Note that the following description assumes that the maintenance terminal apparatus 101 transmits the communication packet data 107 including no program data to the controller 102 before transmission of first communication packet data 107 including the program data. Also, assume that the maintenance terminal apparatus 101 transmits the communication packet data 107 including no program data to the controller 102 after transmission of last communication packet data 107 including the program data.

For this reason, the reception unit 115 receives a plurality of pieces of communication packet data 107 including the program data after reception of the communication packet data 107 including no program data, and then receives the communication packet data 107 including no program data.

The reception unit 115 receives the communication packet data 107 from the packet capturer 103 (step S401). The reception unit 115 outputs the received communication packet data 107 to the control program construction unit 104.

The control program construction unit 104 then disassembles the communication packet data 107 received on this occasion (hereinafter referred to as the communication packet data 107 on this occasion). That is, the control program construction unit 104 disassembles the communication packet data 107 on this occasion into a time stamp, controller information, an instruction command, and the like. The control program construction unit 104 determines whether the program data is included in the communication packet data 107 (step S402).

If the program data is included in the communication packet data 107 on this occasion (YES in step S402), the communication packet data 107 determines whether the program data is included in the communication packet data 107 received on a previous occasion (hereinafter referred to as the communication packet data 107 on the previous occasion) (step S403).

If no program data is included in the communication packet data 107 on the previous occasion (NO in step S403), the control program construction unit 104 generates the time information 108 from the time stamp included in the communication packet data 107 on this occasion. Specifically, the control program construction unit 104 extracts the time stamp included in the communication packet data 107 on this occasion as the time information 108.

The control program construction unit 104 then saves the program data and the controller information 114 included in the communication packet data 107 on this occasion and the time information 108 generated in step S404 in association with each other in a temporary storage region (step S405). The temporary storage region is, for example, a register inside the memory 202 or the processor 201.

On the other hand, if the program data is included in the communication packet data 107 on the previous occasion (YES in step S403), the time information 108 has been already generated. The control program construction unit 104 skips step S404 and saves the program data included in the communication packet data 107 on this occasion in the temporary storage region (step S405). Specifically, the control program construction unit 104 saves the program data included in the communication packet data 107 on this occasion in association with the program data included in the communication packet data 107 on the previous occasion in the temporary storage region.

If no program data is included in the communication packet data 107 on this occasion in step S402 (NO in step S402), the control program construction unit 104 determines whether the program data is included in the communication packet data 107 on the previous occasion (step S406).

If no program data is included in the communication packet data 107 on the previous occasion (NO in step S406), the control program construction unit 104 ends the process.

On the other hand, if the program data is included in the communication packet data 107 on the previous occasion (YES in step S406), the control program construction unit 104 reads out a plurality of pieces of program data, the time information 108, and the controller information 114 from the temporary storage region (step S407).

The control program construction unit 104 then generates the packet-updated program 109 from the plurality of pieces of program data read-out (step S408).

After that, the control program construction unit 104 outputs the generated packet-updated program 109, the time information 108, and the controller information 114 to the difference determination unit 106 (step S409).

The operation of the past program storage unit 105 will next be described with reference to FIG. 6.

The past program storage unit 105 first receives a read request from the difference determination unit 106 (step S501).

The read request includes the time information 108 and the controller information 114.

The past program storage unit 105 then extracts the current program 110 corresponding to the controller information 114 from among the past programs on the basis of the read request and outputs the extracted current program 110 to the difference determination unit 106 (step S502).

More specifically, the past program storage unit 105 extracts, as the current program 110, a past program which is associated with the same controller information 114 as the controller information 114 included in the read request and is associated with the time information 108 indicating a latest time earlier than a time indicated by the time information 108 included in the read request. The past program storage unit 105 then outputs the extracted current program 110 to the difference determination unit 106.

The past program storage unit 105 receives a storage request from the control program construction unit 104 (step S503).

The storage request includes the time information 108, the packet-updated program 109, and the controller information 114.

The past program storage unit 105 then stores the time information 108, the packet-updated program 109, and the controller information 114 included in the storage request in association with one another (step S504).

The operation of the difference determination unit 106 will next be described with reference to FIG. 7.

The difference determination unit 106 receives the time information 108, the packet-updated program 109, the controller information 114, and the current program 110 (step S601).

Specifically, the difference determination unit 106 receives the time information 108, the packet-updated program 109, and the controller information 114 from the control program construction unit 104 and generates a read request using the time information 108 and the controller information 114. The difference determination unit 106 outputs the generated read request to the past program storage unit 105 and receives the current program 110 from the past program storage unit 105.

The difference determination unit 106 then extracts a difference between the packet-updated program 109 and the current program 110 and generates the change state 112 representing the extracted difference (step S602).

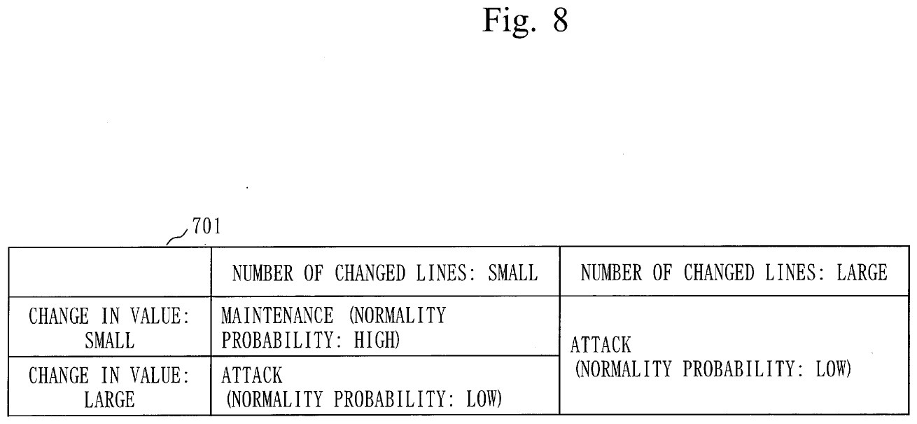

The difference determination unit 106 then obtains the normality probability 113 using the change state 112 generated in step S602 (step S603). In the present embodiment, the difference determination unit 106 uses a normality probability standard 701 illustrated in FIG. 8.

Specifically, the difference determination unit 106 decreases the normality probability 113 with an increase in the number of lines changed from the current program 110 among lines included in the packet-updated program 109. If the number of changed lines is small, the difference determination unit 106 extracts a parameter which has a change in value between the current program 110 and the packet-updated program 109 and determines whether the degree of change in the extracted parameter between the packet-updated program 109 and the current program 110 is large. If the degree of change in the extracted parameter between the packet-updated program 109 and the current program 110 is large, the difference determination unit 106 sets the normality probability 113 to “low”.

Note that the possibility that the packet-updated program 109 is a normal updated program for the current program 110 increases with an increase in the normality probability 113. In other words, the possibility that the packet-updated program 109 is an unauthorized program increases with a decrease in the normality probability 113.

Finally, the difference determination unit 106 outputs, as the determination result 111, the change state 112 and the normality probability 113 (step S604).

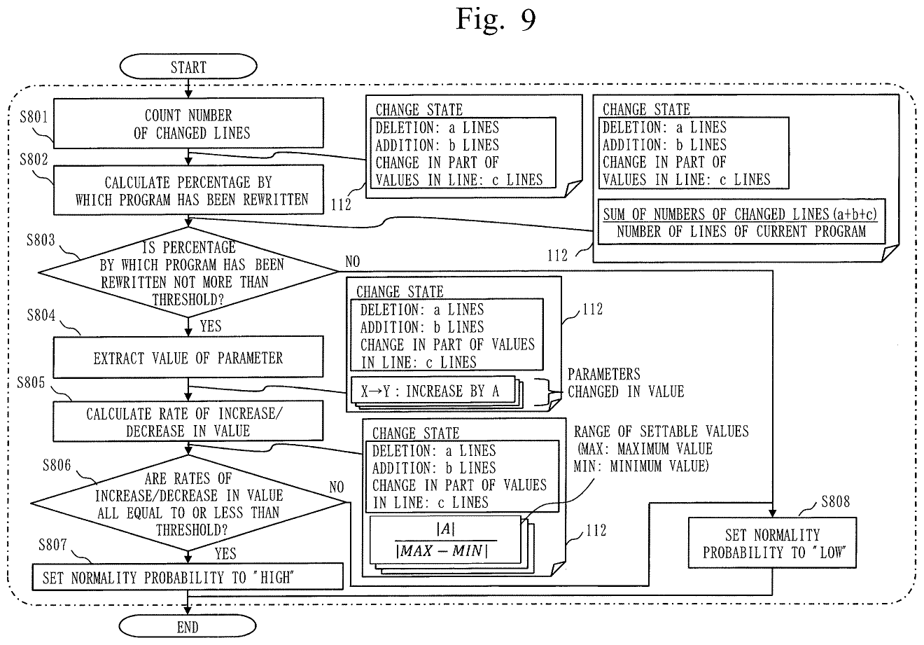

FIG. 9 illustrates details of step S600 in FIG. 7.

A description will be given below using the normality probability standard 701 in FIG. 8.

The difference determination unit 106 first counts the number of lines changed from the current program 110 in the packet-updated program 109 (step S801).

Specifically, the difference determination unit 106 counts, as the change state 112, the number a of lines which are in the current program 110 and have been deleted from the packet-updated program 109, the number b of lines which have been newly added to the packet-updated program 109, and the number c of lines which have been changed in a value of a parameter in the packet-updated program 109.

The difference determination unit 106 then calculates the percentage by which a program has been rewritten (step S802).

Specifically, the difference determination unit 106 calculates the percentage (a+b+c/the number of lines of the current program 110) of the sum (a+b+c) of the numbers of changed lines counted in step S801 to the number of lines of the current program 110.

The difference determination unit 106 then determines whether the percentage calculated in step S802 is equal to or less than a threshold (step S803).

If the percentage calculated in step S802 exceeds the threshold (NO in step S803), the difference determination unit 106 sets the normality probability 113 to “low” (step S808).

On the other hand, if the percentage calculated in step S802 is equal to or less than the threshold (YES in step S803), the difference determination unit 106 extracts a value of a parameter before change from the current program 110 and extracts a value of the parameter after change from the packet-updated program 109 (step S804). The difference determination unit 106 performs the process in step S804 for each of parameters which have changed in value.

The difference determination unit 106 then calculates, for each parameter, the rate of increase or decrease in a value of the parameter (step S805). For example, a change in a value of a parameter from 10 to 25 by 15 is described using the expression “a value of a parameter has increased from a value X to a value Y by A”. That is, the amount of increase in parameter value is denoted by A, and “X→Y: increase by A” is described. If the parameter decreases from the value X to the value Y by A, “X→Y: decrease by A” is described. The difference determination unit 106 calculates the percentage of an absolute value (hereinafter denoted by |A|) of an increase or a decrease in the value of the parameter to a range of values settable as the parameter. Specifically, the difference determination unit 106 acquires a corresponding maximum value (MAX) and a corresponding minimum value (MN) for the parameter from parameter setting value data indicating a range of values settable as each parameter, using the controller information 114. The difference determination unit 106 then calculates |A|/|MAX−MIN|.

The difference determination unit 106 then compares, for each parameter, the rate of increase or decrease in value obtained in step S805 with a threshold (step S806).

If the rates of increase or decrease in value for all the parameters are equal to or less than the threshold (YES in step S806), the difference determination unit 106 sets the normality probability 113 to “high” (step S807).

On the other hand, if any one of the rates of increase or decrease in value exceeds the threshold (NO in step S806), the difference determination unit 106 sets the normality probability 113 to “low” (step S808).

After that, as illustrated in FIG. 7, the difference determination unit 106 outputs the change state 112 and the normality probability 113 as the determination result 111 (step S604).

Note that, if the normality probability 113 is set to “high”, the difference determination unit 106 instructs the control program construction unit 104 to store the packet-updated program 109 in the past program storage unit 105. The control program construction unit 104 outputs a storage request including the time information 108, the packet-updated program 109, and the controller information 114 to the past program storage unit 105 in accordance with the instruction from the difference determination unit 106. The past program storage unit 105 stores the time information 108, the packet-updated program 109, and the controller information 114 in accordance with step S503 and step S504 in FIG. 6. If the normality probability 113 is set to “low”, the difference determination unit 106 instructs the control program construction unit 104 to store the packet-updated program 109 in a storage region other than the past program storage unit 105. The control program construction unit 104 stores, for example, the time information 108, the packet-updated program 109, and the controller information 114 in an external storage region for quarantine in accordance with the instruction from the difference determination unit 106.

Note that although the control program construction unit 104 stores the time information 108, the packet-updated program 109, and the controller information 114 in the past program storage unit 105 or the external storage region here after the normality probability 113 is generated by the difference determination unit 106, the past program storage unit 105 may store the time information 108, the packet-updated program 109, and the controller information 114 in the past program storage unit 105 in parallel with step S409 in FIG. 5.

***Description of Advantageous Effects of Embodiment***

As has been described above, in the present embodiment, the normal task determination apparatus 100 extracts a difference between the packet-updated program 109 and the current program 110 and determines the probability that the packet-updated program 109 is a normal updated packet for the current program 110. For this reason, the present embodiment is capable of preventing the current program 110 from being unauthorizedly updated by the communication packet data 107 transmitted from the maintenance terminal apparatus 101. In particular, the present embodiment is capable of preventing occurrence of a situation in which the communication packet data 107 is transmitted from the maintenance terminal apparatus 101 that is infected with a virus to the controller 102, and the current program 110 for the controller 102 is updated by the unauthorized packet-updated program 109.

### Embodiment 2

In Embodiment 1 described above, the difference determination unit 106 determines the normality probability 113 only by the change state 112. In the present embodiment, a difference determination unit 106 determines a normality probability 113 on the basis of a change state 112 and a schedule for updating of a current program 110.

The present embodiment will mainly describe differences from Embodiment 1. Note that matters not described in the present embodiment are the same as those in Embodiment 1.

***Description of Configuration***

An example of a system configuration according to the present embodiment is the same as illustrated in FIG. 1.

An example of a hardware configuration of a normal task determination apparatus 100 according to the present embodiment is the same as illustrated in FIG. 2.

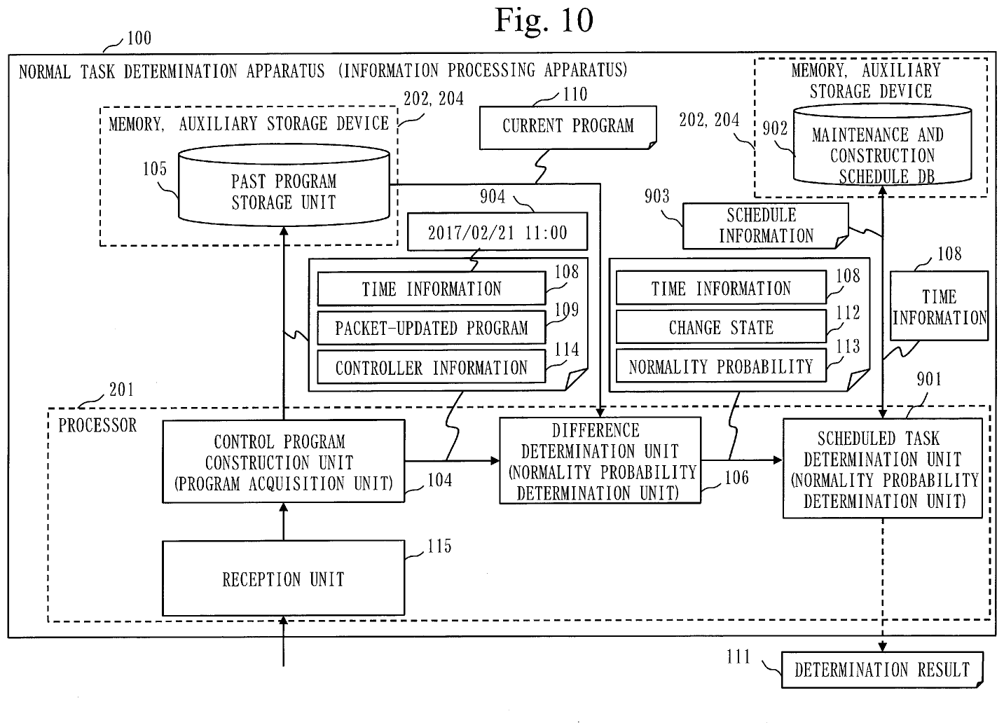

FIG. 10 illustrates an example of a functional configuration of the normal task determination apparatus 100 according to the present embodiment.

In FIG. 10, a scheduled task determination unit 901 and a maintenance and construction schedule DB 902 are added, as compared with the configuration in FIG. 3. In the present embodiment, the difference determination unit 106 does not output a determination result 111 but outputs the time information 108, the change state 112, and the normality probability 113 to the scheduled task determination unit 901. Note that, in the present embodiment, the difference determination unit 106 and the scheduled task determination unit 901 correspond to a normality probability determination unit.

Components other than the scheduled task determination unit 901 and the maintenance and construction schedule DB 902 are the same as those illustrated in FIG. 3, and a description thereof will be omitted.

The scheduled task determination unit 901 receives the time information 108, the change state 112, and the normality probability 113 from the difference determination unit 106. The scheduled task determination unit 901 also outputs the time information 108 to the maintenance and construction schedule DB 902. The scheduled task determination unit 901 then receives schedule information 903 from the maintenance and construction schedule DB 902. The schedule information 903 indicates a scheduled maintenance task or construction task for a controller 102 corresponding to the current program 110. The scheduled task determination unit 901 determines whether the schedule of maintenance task or construction task indicated by the schedule information 903 is consistent with the change state 112. The scheduled task determination unit 901 changes the normality probability 113 if necessary as a result of the determination. For example, if the normality probability 113 received from the difference determination unit 106 is “high” and there is a high possibility that the current program 110 has not been updated to a packet-updated program 109 in the maintenance task or construction task indicated by the schedule information 903, the scheduled task determination unit 901 changes the normality probability 113 to “low”. In contrast, if the normality probability 113 received from the difference determination unit 106 is “low” and there is a high possibility that the current program 110 has been updated to the packet-updated program 109 in the maintenance task or construction task indicated by the schedule information 903, the scheduled task determination unit 901 changes the normality probability 113 to “high”.

The scheduled task determination unit 901 is implemented by a program, like the control program construction unit 104, the difference determination unit 106, and the reception unit 115.

The maintenance and construction schedule DB 902 manages a maintenance and construction schedule table. Scheduled maintenance tasks and construction tasks are described in the maintenance and construction schedule table. The maintenance and construction schedule DB 902 receives the time information 108 from the scheduled task determination unit 901 and extracts a scheduled maintenance task or construction task corresponding to the received time information 108 from the maintenance and construction schedule table. The maintenance and construction schedule DB 902 sends back the schedule information 903 indicating the extracted scheduled maintenance task or construction task to the scheduled task determination unit 901.

The maintenance and construction schedule DB 902 is implemented by the memory 202 or the auxiliary storage device 204.

***Description of Operation***

Operation of the normal task determination apparatus 100 according to the present embodiment will next be described.

A procedure leading up to determination of the normality probability 113 by the difference determination unit 106 is the same as illustrated in Embodiment 1, and a description of the procedure leading up to determination of the normality probability 113 by the difference determination unit 106 will be omitted.

In the present embodiment, the difference determination unit 106 outputs the time information 108, the change state 112, and the normality probability 113 to the scheduled task determination unit 901 when the difference determination unit 106 determines the normality probability 113.

A procedure after the difference determination unit 106 outputs the time information 108, the change state 112, and the normality probability 113 to the scheduled task determination unit 901 will be described below.

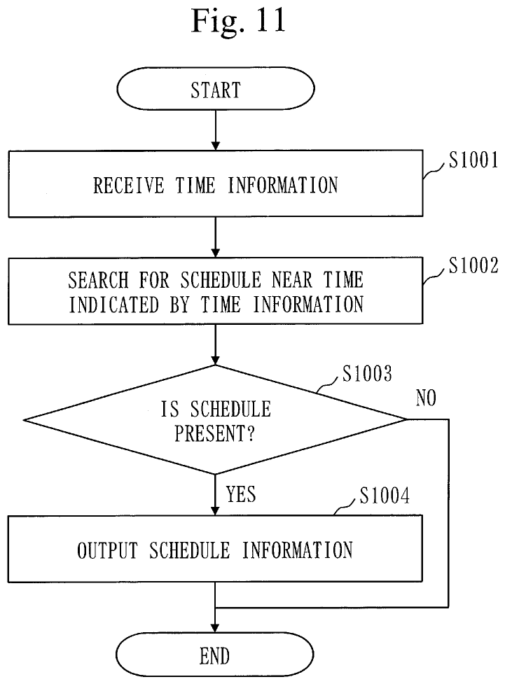

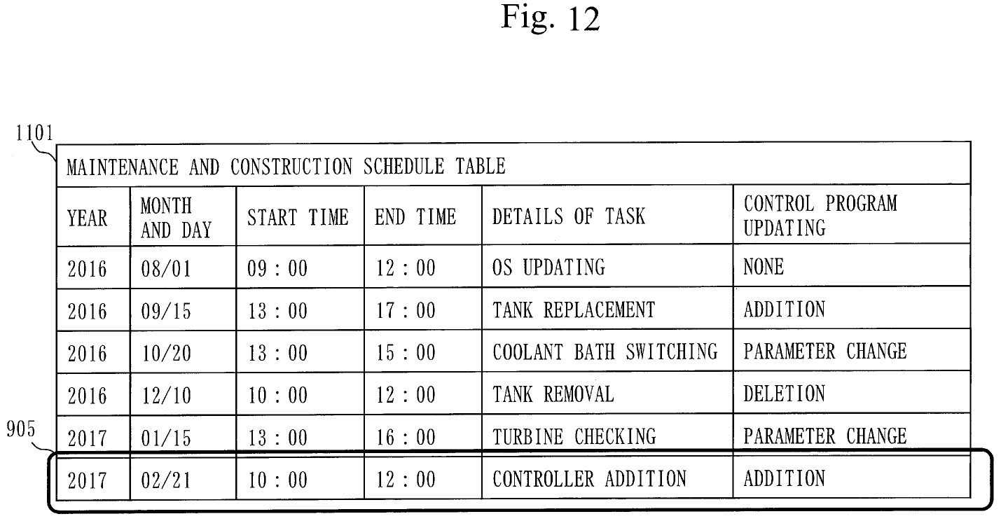

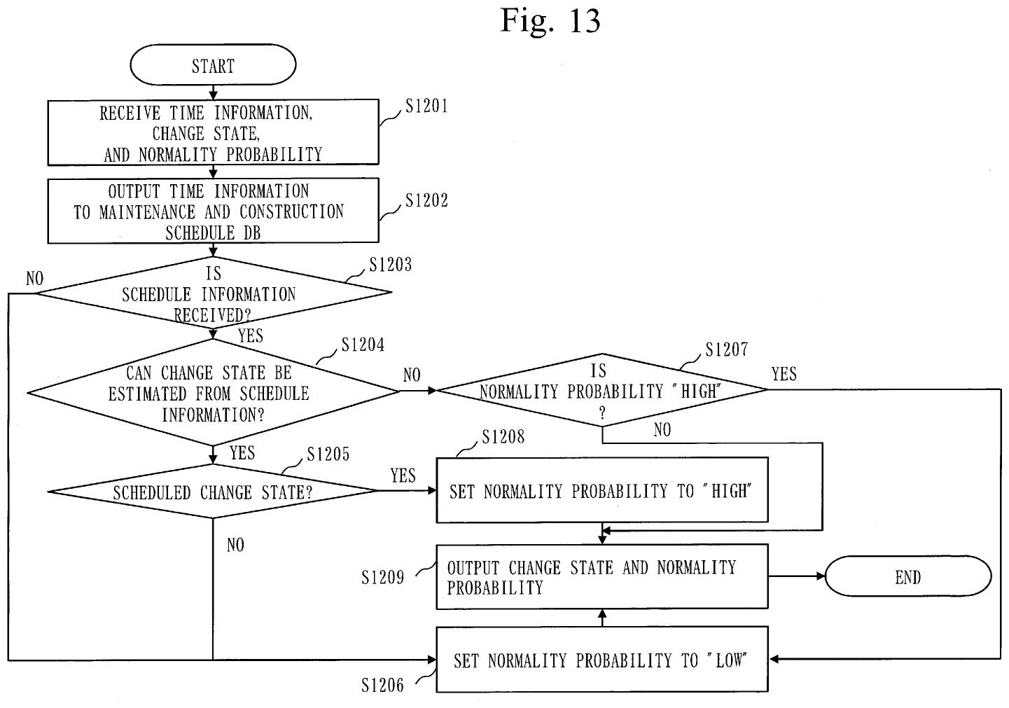

FIG. 11 illustrates operation of the maintenance and construction schedule DB 902. FIG. 12 illustrates an example of the maintenance and construction schedule table managed by the maintenance and construction schedule DB 902. FIG. 13 illustrates operation of the scheduled task determination unit 901.

Operation of the scheduled task determination unit 901 and the maintenance and construction schedule DB 902 will be described below with reference to FIGS. 11 to 13.

As illustrated in FIG. 13, the scheduled task determination unit 901 receives the time information 108, the change state 112, and the normality probability 113 from the difference determination unit 106 (step S1201).

The scheduled task determination unit 901 then outputs the time information 108 to the maintenance and construction schedule DB 902 (step S1202).

As illustrated in FIG. 11, the maintenance and construction schedule DB 902 receives the time information 108 from the scheduled task determination unit 901 (step S1001).

The maintenance and construction schedule DB 902 searches a maintenance and construction schedule table 1101 for a scheduled task near a time indicated by the time information 108 received from the scheduled task determination unit 901 (step S1002).

For example, if the time indicated by the time information 108 is “2017/02/21 11:00” as denoted by reference numeral 904 in FIG. 10, the maintenance and construction schedule DB 902 refers to a year column, a month and day column, a start time column, and an end time column of the maintenance and construction schedule table 1101 and extracts a row indicated by reference numeral 905 in FIG. 12 as a scheduled task near “2017/02/21 11:00”.

As described above, if there is a scheduled task near the time indicated by the time information 108 (YES in step S1003), the maintenance and construction schedule DB 902 outputs the schedule information 903 indicating the scheduled task to the scheduled task determination unit 901 (step S1004).

Note that although not illustrated in FIG. 11, the maintenance and construction schedule table 1101 may include an identifier of a maintenance terminal apparatus 101 and an identifier (for example, a controller name, an IP (Internet Protocol) address, a MAC (Media Access Control) address, or a host name) of the controller 102 to be maintained. The maintenance and construction schedule table 1101 may also include the name of a maintenance tool to be used by the maintenance terminal apparatus 101 or the name of a command (an OS command or a command for the maintenance tool) to be used in maintenance by the maintenance terminal apparatus 101. The maintenance and construction schedule table 1101 may further include a menu of the maintenance tool in the maintenance terminal apparatus 101, a maintenance worker which uses the maintenance terminal apparatus 101, or account information (for example, a user name) to be used in maintenance in the maintenance terminal apparatus 101.

As illustrated in FIG. 13, if the scheduled task determination unit 901 does not receive the schedule information 903 from the maintenance and construction schedule DB 902 (NO in step S1203), the scheduled task determination unit 901 sets the normality probability 113 to “low” (step S1206). Note that if the normality probability 113 acquired from the difference determination unit 106 is already “low”, the scheduled task determination unit 901 need not update the normality probability 113.

On the other hand, if the scheduled task determination unit 901 receives the schedule information 903 from the maintenance and construction schedule DB 902 (YES in step S1203), the scheduled task determination unit 901 determines whether information implying the change state 112 for controller information 114 or information from which the change state 112 can be estimated, is described in the received schedule information 903 (step S1204). For example, if “addition of a device which is to connect with a controller”, “removal of a device connecting with the controller”, “parameter change”, “addition of a function to a control program”, or the like is described in the schedule information 903, the scheduled task determination unit 901 determines that the information implying the change state 112 or the information from which the change state 112 can be estimated, is described in the schedule information 903.

If the information implying the change state 112 or the information from which the change state 112 can be estimated, is described in the schedule information 903 (YES in step S1204), the scheduled task determination unit 901 compares the information described in the schedule information 903 with the change state 112. The scheduled task determination unit 901 then determines whether the change state 112 is a scheduled change state (step S1205). That is, the scheduled task determination unit 901 determines whether updating of the current program 110 to the packet-updated program 109 has been scheduled in a maintenance task or construction task indicated by the schedule information 903.

If the change state 112 is a scheduled change state (YES in step S1205), that is, it can be estimated that updating of the current program 110 to the packet-updated program 109 has been scheduled in the maintenance task or construction task indicated by the schedule information 903, the scheduled task determination unit 901 sets the normality probability 113 to “high” (step S1206). Note that, if the normality probability 113 acquired from the difference determination unit 106 is already “high”, the scheduled task determination unit 901 need not update the normality probability 113.

On the other hand, if the change state 112 is not a scheduled change state (YES in step S1205), the scheduled task determination unit 901 sets the normality probability 113 to “low” (step S1206). Note that, if the normality probability 113 acquired from the difference determination unit 106 is already “low”, the scheduled task determination unit 901 need not update the normality probability 113.

If the change state 112 cannot be estimated from the schedule information 903 (NO in step S1204), the scheduled task determination unit 901 determines whether the normality probability 113 output from the difference determination unit 106 is “high” (step S1207). If the normality probability 113 output from the difference determination unit 106 is “high” (YES in step S1207), the scheduled task determination unit 901 sets the normality probability 113 to “low” (step S1206). If the normality probability 113 output from the difference determination unit 106 is not “high” (NO in step S1207), the scheduled task determination unit 901 performs step S1209.

When the normality probability 113 is fixed, the scheduled task determination unit 901 outputs the change state 112 and the normality probability 113 as the determination result 111 (step S1209).

***Description of Advantageous Effects of Embodiment***

As has been described above, in the present embodiment, the scheduled task determination unit 901 refers to the schedule information 903 and determines the legitimacy of a normality probability determined by the difference determination unit 106. For this reason, according to the present embodiment, it is possible to determine, with higher accuracy, whether the packet-updated program 109 is a legitimate updated program. According to the present embodiment, it is possible to determine whether a worker performs a correct task at a correct time and detect an unauthorized manipulation by the worker.

Note that an operator of the normal task determination apparatus 100 can investigate a past control program updating status and generate a standard for normality probability determination. For example, the operator sets, as updating aspects, deletion of a line, addition of a line, change in a value of a parameter, substitution for a parameter, and the like as a result of investigating the past control program updating status. The operator may set, as the standard for normality probability determination, a weighting factor for each updating aspect on the basis of an occurrence probability. The operator may set, to the standard for normality probability determination, a normal value for the amount of increase or decrease in the number of lines and a normal value for the amount of increase or decrease in a value of a parameter on the basis of the past control program updating status.

Alternatively, the program data may be included in only one piece of communication packet data without being divided for a plurality of pieces of communication packet data.

Although the normality probability 113 has “high” and “low” alone in Embodiments 1 and 2, the normality probability 113 may have three or more levels.

The difference determination unit 106 and the scheduled task determination unit 901 may output the determination result 111 to a tablet terminal used by a worker which performs a maintenance task or a tablet terminal used by a worker which performs a construction task.

### Embodiment 3

In the present embodiment, if a security device which is installed in an industrial control system detects an attack on the industrial control system, the security device transmits an attack detection alert to a normal task determination apparatus 100. The normal task determination apparatus 100 refers to a maintenance and construction schedule DB 902 and determines whether the cause of the attack detection alert is a maintenance task on the industrial control system or an attack. Depending on a method for detecting an attack used by the security device, detection of a process in a maintenance task as an attacking behavior (false detection) may occur. In the present embodiment, the normal task determination apparatus 100 reduces such false detection.

Note that the industrial control system is a system to be protected.

A hardware configuration of the normal task determination apparatus 100 according to the present embodiment is as illustrated in FIG. 1. A functional configuration of the normal task determination apparatus 100 according to the present embodiment is as illustrated in FIG. 10. However, a reception unit 115 of the normal task determination apparatus 100 receives an attack detection alert from a security device which is not illustrated (for example, an intrusion detection apparatus or a log analysis apparatus).

The security device detects attacks on a plurality of controllers 102, a plurality of devices, a plurality of terminals, and a plurality of computing machines included in the industrial control system, and the whole industrial control system. An intrusion detection apparatus which is an example of the security device detects a communication abnormality in a network of the industrial control system. A log analysis apparatus which is an example of the security device collects event logs from the controllers 102, the devices, the terminals, and the computing machines, a log from a communication device, and alert logs from an intrusion detection apparatus, antivirus software, and the like. The log analysis apparatus individually analyzes each of the collected logs. The log analysis apparatus is also capable of analyzing a plurality of logs in association with one another. The log analysis apparatus detects occurrence of a suspicious event through analysis of such a log.

The security device transmits an attack detection alert announcing detection of an attack on the industrial control system to the normal task determination apparatus 100 when the security device detects the attack on the industrial control system. The security device transmits the attack detection alert as the communication packet data 107 to the normal task determination apparatus 100. Note that the security device may notify the normal task determination apparatus 100 of the attack detection alert in the form of a file.

Note that, in the present embodiment, the security device transmits an attack detection alert as the communication packet data 107 to the normal task determination apparatus 100.

Examples of an attack to be detected by the security device include infection with a virus and a service spoiling attack.

An attack detection alert is, for example, composed of the following elements. Each of the elements below indicates an attribute of a detected attack.
An attack detection time (or a period from a start time of the attack to an end time of the attack)
An identifier of an attacked controller, device, terminal, or the like (for example, an IP address, a controller name, a device name, or a terminal name)
An identifier of an attacking controller, device, terminal, or the like (for example, an IP address, a controller name, a device name, or a terminal name)
Details of the attack (represented by, for example, an alert identifier or a character string indicating an attack name)
Information announcing a status at the time of attack detection

The above-described “information announcing the status at the time of attack detection” is, for example, a command (which may include an argument) used in the attack, a name of a file or a repository which an attacker has attempted to manipulate, a name of a program or a tool used in the attack, a menu name in the program or tool, or a name of a process or a service related to the attack. The “information announcing the status at the time of attack detection” may include a name of an account used in the attack. If an attempt to log in unauthorizedly is detected, an account name with which an attempt to log in has been made, may be included in the “information announcing the status at the time of attack detection”.

Note that above-described examples of the “details of the attack” and the “information announcing the status at the time of attack detection” are just examples and that “details of an attack” and the “information announcing a status at the time of attack detection” differ between security devices.

In the present embodiment, the reception unit 115 outputs a received attack detection alert to a scheduled task determination unit 901.

The scheduled task determination unit 901 interprets the attack detection alert and extracts elements as described above from the attack detection alert.

The scheduled task determination unit 901 searches the maintenance and construction schedule DB 902, using an attack detection time and an identifier of an attacked controller or the like as search keys. A search method is the same as that illustrated in Embodiment 2. A schedule for maintenance tasks on the industrial control system is described in the maintenance and construction schedule DB 902.

If corresponding schedule information 903 is retrieved from the maintenance and construction schedule DB 902, the scheduled task determination unit 901 determines that the cause of occurrence of the attack detection alert is a maintenance task. If no corresponding schedule information 903 is retrieved, the scheduled task determination unit 901 determines that the cause of occurrence of the attack detection alert is not a maintenance task but an attack.

The scheduled task determination unit 901 outputs the determination result as a determination result 111 to the outside. At this time, a change state 112 is not set in the determination result 111. If the scheduled task determination unit 901 determines that the cause of the attack detection alert is an attack, the scheduled task determination unit 901 sets a normality probability 113 of the determination result 111 to “low”. On the other hand, if the scheduled task determination unit 901 determines that the cause of the attack detection alert is a maintenance task, the scheduled task determination unit 901 sets the normality probability 113 of the determination result 111 to “high”. Alternatively, the scheduled task determination unit 901 may omit the time information 108 and the normality probability 113 and output the determination result 111 that is composed only of information indicating “maintenance” or “attack” as the cause of the attack detection alert.

In the present embodiment, the determination result 111 is output to, for example, a terminal apparatus of a monitoring staff member which monitors for an attack detection alert from the security device. If the normal task determination apparatus 100 and the terminal apparatus of the monitoring staff member are separate apparatuses, the scheduled task determination unit 901 sets the determination result 111 included in a notification packet and transmits the notification packet to the terminal apparatus of the monitoring staff member. If the normal task determination apparatus 100 is the terminal apparatus of the monitoring staff member, the scheduled task determination unit 901, for example, displays the determination result 111 on a display apparatus.

The scheduled task determination unit 901 may make a search using an identifier of an attacking controller or the like instead of an identifier of an attacked controller or the like at the time of search through the maintenance and construction schedule DB 902.

If the corresponding schedule information 903 is retrieved, the scheduled task determination unit 901 may refer to the “information announcing a status at the time of attack detection” included in an attack detection alert and determine whether the cause of the attack detection alert is a maintenance task or an attack.

For example, assume that a command used in a maintenance task is described in the schedule information 903, and a command used in an attack is described as the “information announcing a status at the time of attack detection” in an attack detection alert. In this case, the scheduled task determination unit 901 compares the command described in the schedule information 903 with the command described in the attack detection alert. If the commands match, the scheduled task determination unit 901 determines that the attack detection alert has been issued due to the command used in a maintenance task and determines that the cause of the attack detection alert is the maintenance task. On the other hand, if the commands do not match, the scheduled task determination unit 901 determines that a command not scheduled in the maintenance task has been executed and determines that the cause of the attack detection alert is an attack.

Assume that a name of a program (or a name of a tool or a menu name) used in a maintenance task is described in the schedule information 903, and a name of a program (or a name of a tool or a menu name) used in an attack is described as the “information announcing a status at the time of attack detection” in an attack detection alert. In this case, the scheduled task determination unit 901 compares the name of the program (or the name of the tool or the menu name) described in the schedule information 903 with the name of the program (or the name of the tool or the menu name) described in the attack detection alert. If the names of the programs (or the names of the tools or the menu names) match, the scheduled task determination unit 901 determines that the cause of the attack detection alert is a maintenance task. On the other hand, if the names of the programs (or the names of the tools or the menu names) do not match, the scheduled task determination unit 901 determines that the cause of the attack detection alert is an attack.

Assume that an account name used in a maintenance task is described in the schedule information 903, and an account name used in an attack is described as the “information announcing a status at the time of attack detection” in an attack detection alert. In this case, the scheduled task determination unit 901 compares the account name described in the schedule information 903 with the account name described in the attack detection alert. If the account names match, the scheduled task determination unit 901 determines that the cause of the attack detection alert is a maintenance task. On the other hand, if the account names do not match, the scheduled task determination unit 901 determines that the cause of the attack detection alert is an attack.

Assume that a name of a file (or a name of a repository) referred to (for example, read or updated) in a maintenance task is described in the schedule information 903, and a name of a file (or a name of a repository) manipulated by an attacker is described as the “information announcing a status at the time of attack detection” in an attack detection alert. In this case, the scheduled task determination unit 901 compares the name of the file (or the name of the repository) described in the schedule information 903 with the name of the file (or the name of the repository) described in the attack detection alert. If the names of the files (or the names of the repositories) match, the scheduled task determination unit 901 determines that the cause of the attack detection alert is a maintenance task. On the other hand, if the names of the files (or the names of the repositories) do not match, the cause of the attack detection alert is an attack.

Similarly, if the “information announcing a status at the time of attack detection” in the attack detection alert is not extracted as the schedule information 903, the scheduled task determination unit 901 determines that the cause of the attack detection alert is an attack.

Note that possible attackers are considered to be a person who manipulates a maintenance terminal apparatus 101, malware operating in a different terminal apparatus which remotely manipulates the maintenance terminal apparatus 101, and malware operating in the maintenance terminal apparatus 101. An attacker is not limited to a particular one here.

***Description of Advantageous Effects of Embodiment***

As has been described above, in the present embodiment, the scheduled task determination unit 901 refers to the maintenance and construction schedule DB 902 and determines the cause of an attack detection alert from a security device, such as an intrusion detection apparatus or a log analysis apparatus. For this reason, the present embodiment has the advantage that a monitoring staff member who monitors for an attack detection alert from the security device need not investigate the cause of an attack detection alert for himself/herself. If an attack detection alert is derived from false detection due to maintenance, the monitoring staff member only needs to check the determination result 111 from the scheduled task determination unit 901, and the burden on the monitoring staff member can be reduced.

The embodiments of the present invention have been described above. These embodiments may be combined and carried out.

Alternatively, one of the embodiments may be partially carried out.

Alternatively, the embodiments may be partially combined and carried out.

Note that the present invention is not limited to the embodiments and that the embodiments can be variously changed, as needed.

***Description of Hardware Configuration***

Finally, a supplemental explanation of the hardware configuration of the normal task determination apparatus 100 will be given.

The processor 201 is an IC (Integrated Circuit) which performs processing.

The processor 201 is, for example, a CPU (Central Processing Unit) or a DSP (Digital Signal Processor).

The memory 202 is, for example, a RAM (Random Access Memory).

The auxiliary storage device 204 is, for example, a ROM (Read Only Memory), a flash memory, or an HDD (Hard Disk Drive).

The communication interface 203 includes a receiver which receives data and a transmitter which transmits data.

The communication interface 203 is, for example, a communication chip or an NIC (Network Interface Card).

The input/output interface 205 is, for example, a keyboard, a mouse, or a display device.

The auxiliary storage device 204 also stores an OS (Operating System).

At least a part of the OS is then executed by the processor 201.

The processor 201 executes a program which implements functions of the control program construction unit 104, the difference determination unit 106, the reception unit 115, and the scheduled task determination unit 901 while executing at least a part of the OS.

The processor 201 executes the OS, thereby performing task management, memory management, file management, communication control, and the like.

At least any of information, data, signal values, and variable values indicating results of processing by the control program construction unit 104, the difference determination unit 106, the reception unit 115, and the scheduled task determination unit 901 are stored in at least any of the memory 202, the auxiliary storage device 204, and a register and a cache memory inside the processor 201.

The program that implements the functions of the control program construction unit 104, the difference determination unit 106, the reception unit 115, and the scheduled task determination unit 901 may be stored in a portable storage medium, such as a magnetic disk, a flexible disk, an optical disc, a compact disc, a Blu-ray (a registered trademark) disc, or a DVD.

The “unit” in each of the control program construction unit 104, the difference determination unit 106, the reception unit 115, and the scheduled task determination unit 901 may be replaced with the “circuit”, the “step”, the “procedure”, or the “process”.

The normal task determination apparatus 100 may be implemented as an electronic circuit, such as a logic IC (Integrated Circuit), a GA (Gate Array), an ASIC (Application Specific Integrated Circuit), or an FPGA (Field-Programmable Gate Array).

In this case, the control program construction unit 104, the difference determination unit 106, the reception unit 115, and the scheduled task determination unit 901 are each implemented as a portion of the electronic circuit.

Note that the processor and the above-described electronic circuits are also collectively called processing circuitry.

### REFERENCE SIGNS LIST

100: normal task determination apparatus; 101: maintenance terminal apparatus; 102: controller; 103: packet capturer; 104: control program construction unit; 105: past program storage unit; 106: difference determination unit; 107: communication packet data; 108: time information; 109: packet-updated program; 110: current program; 111: determination result; 112: change state; 113: normality probability; 114: controller information; 115: reception unit; 201: processor; 202: memory; 203: communication interface; 204: auxiliary storage device; 205: input/output interface; 701: normality probability standard; 901: scheduled task determination unit; 902: maintenance and construction schedule DB; 903: schedule information; 1101: maintenance and construction schedule table

1. An information processing apparatus comprising:
processing circuitry
to receive communication packet data used for updating of a current program, the communication packet data being transmitted from a program updating management apparatus which manages program updating;
to acquire an updated program for the current program as a packet-updated program, using the communication packet data; and
to analyze a difference between the current program and the packet-updated program and to determine a probability that the packet-updated program is a normal updated program for the current program.

2. The information processing apparatus according to claim 1, wherein
the processing circuitry analyzes the amount of the difference between the current program and the packet-updated program and determines the probability.

3. The information processing apparatus according to claim 1, wherein
the processing circuitry analyzes the amount of the difference between the current program and the packet-updated program and the degree of change in a value of a parameter which has a change in value between the current program and the packet-updated program, and determines the probability.

4. The information processing apparatus according to claim 1, wherein
the processing circuitry analyzes a schedule for updating of the current program and the difference between the current program and the packet-updated program, and determines the probability.

5. The information processing apparatus according to claim 1, wherein
the processing circuitry outputs at least either one of the difference and the probability to a prescribed terminal apparatus.

6. The information processing apparatus according to claim 1, wherein
the processing circuitry checks an attack attribute indicated by an attack detection alert announcing detection of an attack on a system to be protected against a schedule for a maintenance task on the system to be protected, and determines whether the attack detection alert is issued due to the maintenance task on the system to be protected or an attack on the system to be protected.

7. An information processing method comprising:
receiving communication packet data used for updating of a current program, the communication packet data being transmitted from a program updating management apparatus which manages program updating;
acquiring an updated program for the current program as a packet-updated program, using the communication packet data; and
analyzing a difference between the current program and the packet-updated program and determining a probability that the packet-updated program is a normal updated program for the current program.

8. A non-transitory computer readable medium storing an information processing program that causes a computer to execute:
a reception process of receiving communication packet data used for updating of a current program, the communication packet data being transmitted from a program updating management apparatus which manages program updating;
a program acquisition process of acquiring an updated program for the current program as a packet-updated program, using the communication packet data; and
a normality probability determination process of analyzing a difference between the current program and the packet-updated program and determining a probability that the packet-updated program is a normal updated program for the current program.
